(19) United States
(12) Patent Application Publication
(10) Pub. No.: US 2015/0015516 A1
(43) Pub. Date: Jan. 15, 2015

(54) ELECTRONIC DEVICE AND METHOD FOR INVOKING APPLICATIONS OF THE ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHAN-JIA AO, Wuhan (CN); JIAN-HUNG HUNG, New Taipei (TW)

(21) Appl. No.: 14/332,349

(22) Filed: Jul. 15, 2014

(30) Foreign Application Priority Data
Jul. 15, 2013 (CN) 2013102941999

(51) Int. Cl. G06F 3/023; G06F 3/041

(52) U.S. Cl. CPC G06F 3/0233; G06F 3/0412; G06F 2203/04104
USPC 345/173

(57) ABSTRACT

In a method for invoking an application of an electronic device, a specified keystroke related to the application is preset. The method detects a first operation operated on the specified keystroke after the electronic device is locked. When the first operation has been detected, operation time of the first operation is recorded. If the specified keystroke has been operated again in a predetermined time period, the method unlocks the electronic device and invokes the specified application to be executed. If the specified keystroke has not been operated again in the predetermined time period, the method executes an original function of the specified keystroke.

### CROSS-REFERENCE TO RELATED APPLICATIONS

This application claims priority to Chinese Patent Application No. 201310294199.9 filed on Jul. 15, 2013 in the China Intellectual Property Office, the contents of which are incorporated by reference herein.

### FIELD

Embodiments of the present disclosure relate to applications management technology, and particularly to an electronic device and a method for invoking an application of the electronic device.

### BACKGROUND

When an electronic device is locked, a display function and functions (e.g. touch or display functions of a display) of the electronic device may be disabled. If a user wants to invoke one application after the electronic device is locked, the user needs to press a preset keystroke (e.g. a home keystroke) or a combination of keystrokes of the electronic device for lighting a display of the electronic device. The user must further execute preset unlocking operations for unlocking the electronic device. After the electronic device is unlocked, the user can find and execute the application. The user cannot invoke the application directly when the electronic device is locked.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including an application invoking system.

FIG. 2 is a diagrammatic view of one embodiment of a specified keystroke of the electronic device of FIG. 1.

FIG. 3 is a flowchart of one embodiment of a method of invoking an application of the electronic device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

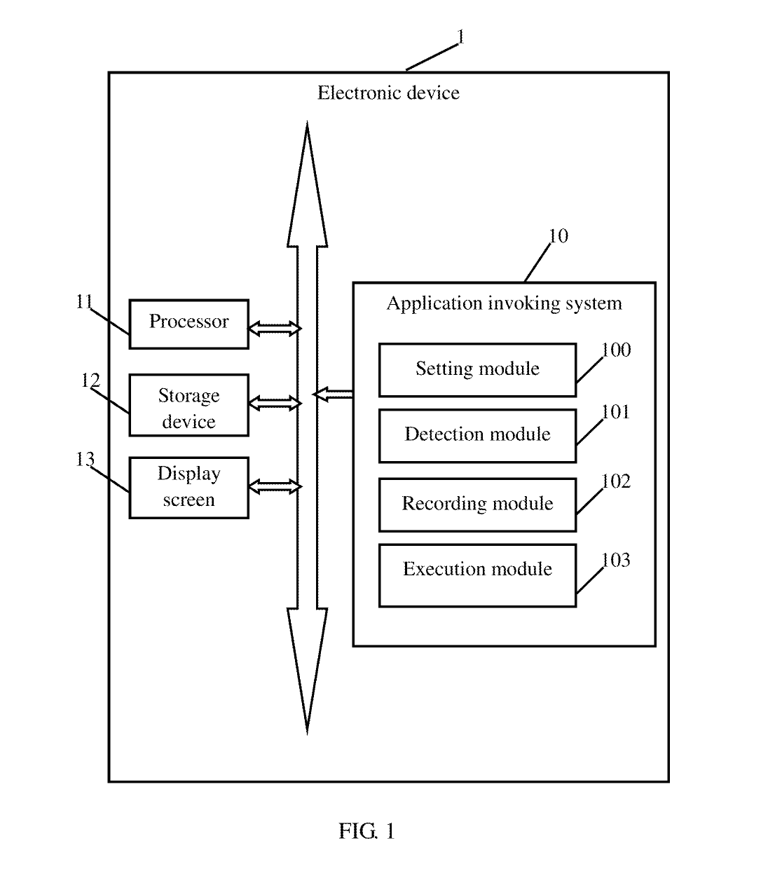

FIG. 1 is a block diagram of one embodiment of an electronic device including an application invoking system. In one embodiment, the electronic device 1 can be a mobile phone, a tablet computer, a notebook computer, or any other electronic device. The electronic device 1 further includes, but is not limited to, an application invoking system 10, at least one processor 11, a storage device 12, and a display screen 13. In one embodiment, the application invoking system 10 can preset a specified keystroke related to a specified application of the electronic device 1, and unlock the electronic device and execute the related specified application when the electronic device 1 is locked and the preset keystroke has been operated twice in a preset time period.

The at least one processor 11 executes one or more computerized codes and other applications of the electronic device 1 to provide functions of the application invoking system 10. The storage device 12 can be a memory of the electronic device 1 or an external storage card, such as a smart media card or a secure digital card. The display screen 13 can be a liquid crystal display (LCD) screen or a touch-sensitive screen.

In this embodiment, the application invoking system 10 includes, but is not limited to, a setting module 100, a detection module 101, a recording module 102, and an execution module 103. The modules 100-103 include computerized code in the form of one or more programs that are stored in the storage device 12. The computerized code includes instructions that are executed by the at least one processor 11 to provide functions of the application invoking system 10.

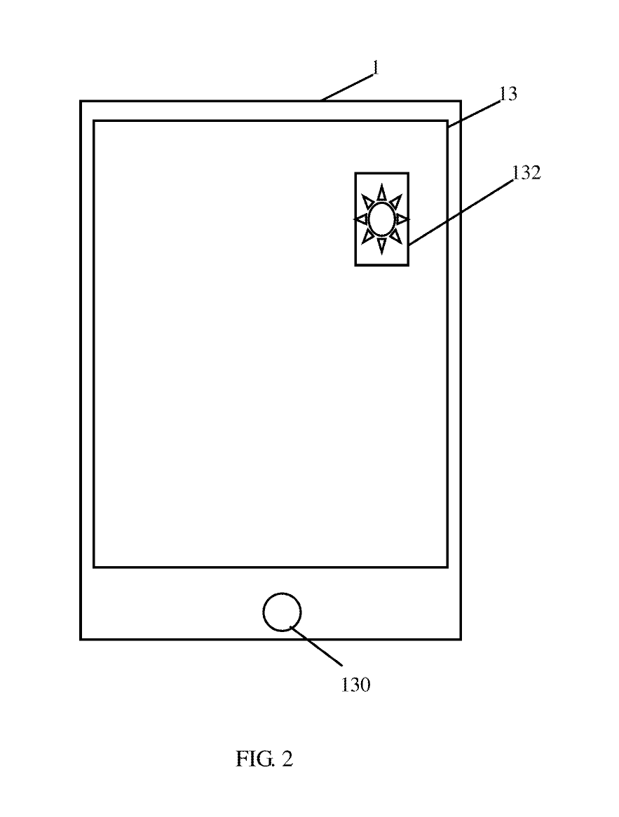

The setting module 100 presets a specified keystroke related to the specified application. The specified application can be any application of the electronic device which is frequently used by a user, such as a message service application, a phone service application, a game application, or a video player, for example. FIG. 2 is a diagrammatic view of one embodiment of the specified keystroke of the electronic device of FIG. 1. The specified keystroke can be a physical keystroke 130 (for example, a power keystroke, a home keystroke, or a volume keystroke) of the electronic device 1, or can be a virtual keystroke 132 displayed on the display screen 13. The virtual keystroke 132 can be a virtual icon or a virtual button, for example.

In the embodiment, the specified keystroke has an original function. For example, the original function of the specified keystroke can be to display or exit an unlocking interface on the display screen 13 of the electronic device 1. In other embodiment, the electronic device can be locked or unlocked when the original function of the specified keystroke is executed, or a volume of the electronic device 1 can be adjusted when the original function of the specified keystroke is executed.

If the display screen 13 is a touch-sensitive screen and the specified keystroke is a virtual keystroke 132, the virtual keystroke 132 can be displayed on the display screen 13 after the electronic device 1 is locked. The displaying of the virtual keystroke 132 can be triggered by a preset touch operation on the display screen 13. The preset touch operation can be a click operation on the display screen 13, a sliding operation on the display screen 13, or multi-touch operations on the display screen 13.

The detection module 101 detects a first operation operated on the specified keystroke when the electronic device 1 is locked. For example, the detection module 101 detects a clicking operation or a pressing operation of the specified keystroke for the first time.

When the detection module 101 detects the first operation of the specified keystroke, the recording module 102 records operation time of the first operation operated of the specified keystroke.

The detection module 101 further determines whether the specified keystroke has been operated again in a predetermined time period (for example, 1 seconds) after the first operation of the specified keystroke. The predetermined time period can be preset according to a user's operation habit. In one embodiment, the detection module 101 can control a timer to start timing a duration after recording the operation time of the first operation.

When the duration does not reach the predetermined time period and once the specified keystroke is operated, the detection module 101 determines that the specified keystroke has been operated again in the predetermined time period. When the duration reaches the predetermined time period and the specified keystroke has not been operated, the detection module 101 determines that the specified keystroke has not been operated again in the predetermined time period. After determining whether the specified keystroke has been operated again in the predetermined time period, the recorded operation time and the timed duration are reset.

When the detection module 101 determines that the specified keystroke has been operated again in the predetermined time period, the execution module 103 unlocks the electronic device 1 and invokes the specified application to be executed.

When the detection module 101 determines that the specified keystroke has not been operated again in the predetermined time period, the execution module 103 executes the original function of the specified keystroke.

In other embodiments, if the original function includes at least two functions of the electronic device, the execution module 103 executes a corresponding function according to an state of the electronic device 1. For example, if the original function includes a first function of entering an unlocking interface and a second function of exiting the unlocking interface, the execution module 103 executes the first function if the electronic device 1 is in a locked state, or the execution module 103 executes the second function if the electronic device 1 displays the unlocking interface.

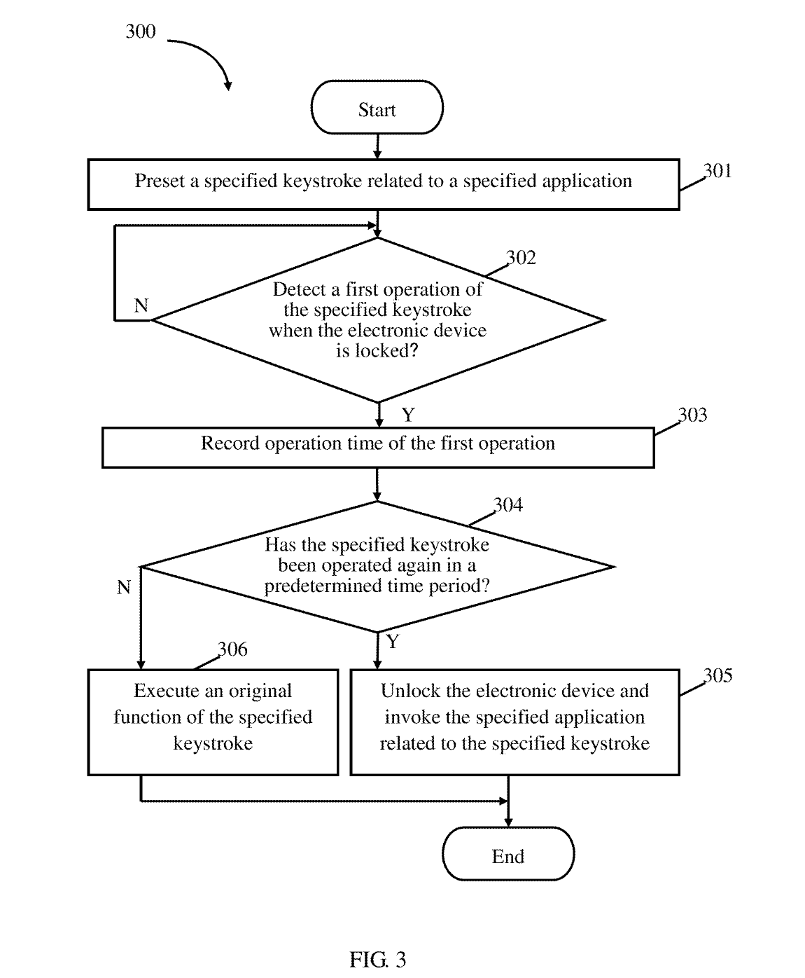

FIG. 3 is a flowchart of one embodiment of a method 300 for invoking an application of an electronic device. Depending on the embodiment, additional blocks can be added, others removed, and the ordering of the blocks can be changed. In the embodiment, the method 300 is performed by execution of computer-readable software program codes or instructions by at least one processor of a computing device. The method 300 is provided by way of example, as there are a variety of ways to carry out the method. The method 300 described below can be carried out using the configurations illustrated in FIGS. 1, for example, and various elements of these figures are referenced in explaining method 300. Each block shown in FIG. 3 represents one or more processes, methods or subroutines, carried out in the method 300. Additionally, the illustrated order of blocks is by example only and the order of the blocks can change according to the present disclosure. The example method 300 can begin at block 301.

In block 301, the setting module presets a specified keystroke related to a specified application. The specified application can be any frequently used application of the electronic device. The specified keystroke can be a physical keystroke 130 of the electronic device 1 or can be a virtual keystroke 132 displayed on the display screen 13. The virtual keystroke 132 can be a virtual icon or a virtual button, for example.

In block 302, the detection module detects a first operation on the specified keystroke when the electronic device 1 is locked. For example, the detection module detects a clicking operation or a pressing operation on the specified keystroke for the first time. If the detection module detects the first operation of the specified keystroke, block 303 is implemented. If the detection module does not detect any operation of the specified keystroke, block 302 is repeated.

In block 303, the recording module records operation time of the first operation of the specified keystroke.

In block 304, the detection module determines whether the specified keystroke has been operated again in a predetermined time period after the first operation of the specified keystroke. In at least one embodiment, the detection module can control a timer to start timing a duration after recording the operation time of the first operation. When the duration does not reach the predetermined time period and once the specified keystroke is operated, the detection module determines that the specified keystroke has been operated again in the predetermined time period, and block 305 is implemented. When the duration reaches the predetermined time period and the specified keystroke has not been operated, the detection module determines that the specified keystroke has not been operated again in the predetermined time period, and block 306 is implemented.

In block 305, the execution module unlocks the electronic device 1 and invokes the specified application to be executed.

In block 306, the execution module executes the original function of the specified keystroke, and the procedure ends.

All of the processes described above can be embodied in, and fully automated via, functional code modules executed by one or more general purpose processors such as the processor 11. The code modules can be stored in any type of non-transitory readable medium or other storage device such as the storage device 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for invoking an application of an electronic device, the method comprising:
detecting, when the electronic device is locked, a first operation of a specified keystroke related to the application;
recording, when the first operation of the specified keystroke has been detected, an operation time of the first operation of the specified keystroke;
determining whether the specified keystroke has been operated again in a predetermined time period; and
unlocking, when the specified keystroke has been operated again in the predetermined time period, the electronic device and invoking the application to be executed; or
executing, when the specified keystroke has not been operated again in the predetermined time period, an original function of the specified keystroke.

2. The method according to claim 1, wherein the specified keystroke comprises a physical keystroke of the electronic device, and a virtual keystroke displayed on a display screen of the electronic device.

3. The method according to claim 2, further comprising:
displaying the virtual keystroke on the display screen when the electronic device is locked and a preset touch operation has been detected, if the specified keystroke is the virtual keystroke.

4. The method according to claim 3, wherein the preset touch operation is a click operation on the display screen, a sliding operation on the display screen, or multi-touch operations on the display screen.

5. The method according to claim 1, further comprising:
starting timing a duration after recording the operation time of the first operation; and
determining that the specified keystroke has been operated again in the predetermined time period, when the timed duration does not reach the predetermined time period and once the specified keystroke is operated; or
determining that the specified keystroke has not been operated again in the predetermined time period, when the duration reaches the predetermined time period and the specified keystroke has not been operated.

6. The method according to claim 5, further comprising:
resetting the recorded operation time and the timed duration after the specified keystroke is determined to be operated again in the predetermined time period.

7. A non-transitory storage medium storing a set of instructions, when executed by at least one processor of an electronic device, cause the at least one processor to perform a method for invoking an application of the electronic device, the method comprising:
presetting a specified keystroke related to the application;
detecting, when the electronic device is locked, a first operation operated on the specified keystroke;
recording, when the first operation of the specified keystroke has been detected, operation time of the first operation of the specified keystroke;
determining whether the specified keystroke has been operated again in a predetermined time period; and
unlocking, when the specified keystroke has been operated again in the predetermined time period, the electronic device and invoking the specified application to be executed; or
executing, when the specified keystroke has not been operated again in the predetermined time period, an original function of the specified keystroke.

8. The storage medium according to claim 7, wherein the specified keystroke comprises a physical keystroke of the electronic device, and a virtual keystroke displayed on a display screen of the electronic device.

9. The storage medium according to claim 8, wherein the method further comprises:
displaying the virtual keystroke on the display screen when the electronic device is locked and a preset touch operation has been detected, if the specified keystroke is the virtual keystroke or icon.

10. The storage medium according to claim 9, wherein the preset touch operation is a click operation on the display screen, a sliding operation on the display screen, or multi-touch operations on the display screen.

11. The storage medium according to claim 7, wherein the method further comprises:
starting timing a duration after recording the operation time of the first operation; and
determining that the specified keystroke has been operated again in the predetermined time period, when the timed duration does not reach the predetermined time period and once the specified keystroke is operated; or
determining that the specified keystroke has not been operated again in the predetermined time period, when the duration reaches the predetermined time period and the specified keystroke has not been operated.

12. The storage medium according to claim 11, wherein the method further comprises:
resetting the recorded operation time and the timed duration after the specified keystroke is determined to be operated again in the predetermined time period.

13. An electronic device, comprising:
a display screen;
at least one processor; and
a storage device storing one or more programs, which when executed by the at least one processor, cause the at least one processor to:
preset a specified keystroke related to an application of the electronic device;
detect, when the electronic device is locked, a first operation operated on the specified keystroke;
record, when the first operation of the specified keystroke has been detected, operation time of the first operation of the specified keystroke;
determine whether the specified keystroke has been operated again in a predetermined time period;
unlock, when the specified keystroke has been operated again in the predetermined time period, the electronic device and invoke the specified application to be executed; or
execute, when the specified keystroke has not been operated again in the predetermined time period, an original function of the specified keystroke.

14. The electronic device according to claim 13, wherein the specified keystroke comprises a physical keystroke of the electronic device, and a virtual keystroke displayed on the display screen.

15. The electronic device according to claim 14, wherein the one or more programs further cause the at least one processer to display the virtual keystroke or icon on the display screen when the electronic device is locked and a preset touch operation has been detected, if the specified keystroke is the virtual keystroke or icon.

16. The electronic device according to claim 14, wherein the preset touch operation is a click operation on the display screen, a sliding operation on the display screen, or multi-touch operations on the display screen.

17. The electronic device according to claim 13, wherein the one or more programs further cause the at least one processer to:
start timing a duration after recording the operation time of the first operation;
determine that the specified keystroke has been operated again in the predetermined time period, when the timed duration does not reach the predetermined time period and once the specified keystroke is operated; or
determine that the specified keystroke has not been operated again in the predetermined time period, when the duration reaches the predetermined time period and the specified keystroke has not been operated.

18. The electronic device according to claim 13, wherein the one or more programs further cause the at least one processer to reset the recorded operation time and the timed duration after the specified keystroke is determined to be operated again in the predetermined time period.
